(19) United States
(12) Patent Application Publication
(10) Pub. No.: US 2013/0161045 A1
(43) Pub. Date: Jun. 27, 2013

(54) IMPACT BODY AND TRANSMISSION MODULE HAVING THE SAME

(71) Applicant: HYPHONE MACHINE INDUSTRY CO., LTD., Taichung City (TW)

(72) Inventor: Chih-Ming TING, Taichung City (TW)

(73) Assignee: HYPHONE MACHINE INDUSTRY CO., LTD., Taichung City (TW)

(21) Appl. No.: 13/725,509

(22) Filed: Dec. 21, 2012

(30) Foreign Application Priority Data
Dec. 27, 2011 (TW) 100224737

(51) Int. Cl. B25D 17/06

(52) U.S. Cl. CPC B25D 17/06
USPC 173/94

(57) ABSTRACT

An impact body adapted for being mounted to a transmission module is provided. The transmission module includes a rotation portion formed with a receiving space and an axle disposed in the receiving space. The impact body is pivotally mounted to the rotation portion and received in the receiving space. A protrusion integrally extends outwardly from the other side of the impact body to allow the impact body swings around the protrusion. Whereby, the transmission module is easy to produce and assemble, has a lighter weight or greater rotary output power, and can improve transmission efficiency and lifetime, thus resulting in great inventive effects for use.

### BACKGROUND OF THE INVENTION

1. Field of the Invention

The present invention relates to a rotary type impact tool.

2. Description of the Prior Art

A conventional rotary type impact tool usually uses a pneumatic motor to drive the impact transmission module to rotate. The impact transmission module includes a mechanism, which can produce impact and impact force, disposed therein, such as an impact body and impact frame. Through the front end of the impact transmission module, the conventional rotary type impact tool can output a rotary output power to achieve impact effect. TW M379496, TW M399005, TW M396741, U.S. Pat. No. 7,510,023 and U.S. Pat. No. 7,147,063 disclose tools that are like the above-mentioned conventional rotary type impact tool.

Regarding the above-mentioned conventional rotary type impact tool, in the impact transmission module, two pins are disposed at two sides of the impact body, so that the impact body can swing and be limited to within a limited swinging range. Hence, the motion of the impact body can be effectively controlled, and the impact body impacts an axle to produce impact force for use.

An impact device like the above-mentioned conventional rotary type impact tool is also disclosed in TW M412846. In TW M412846, the pin engages against only one side of the impact body, and the other side of the impact body is engaged against the protrusion which is integrally formed as a part of the impact frame, so as to reduce the depth of the required drill hole for the impact frame, and thus lowering technical requirements for producing.

However, there are some problems hard to be overcome for producing the impact device disclosed in TW M412846. The impact frame has to be formed with the protrusion, and the protrusion is located in the impact space inside the impact frame, so that the impact frame can be interfered by other portions thereof and is hard to be produced. In addition, as the protrusion integrally formed as a part of the impact frame engages against the impact body, the orientation direction for assembling the impact body is limited according to the position of the protrusion. Therefore, two adjacent impact bodies have to be assembled in respective specific assembling orientation directions and cannot be assembled in reverse, thus resulting in uneasily-assembled problems. Besides, since the protrusion is integrally formed as a part of the impact frame, the protrusion only functions as the single pin does. In other words, the impact bodies mounted in the impact frame and the protrusion are two different components, and consequentially, the impact bodies and the protrusion will form a gap therebetween. As such, the vibration issue of the impact body will get worse, and it can lower the transmission efficiency of the impact device and reduce the lifetime of the impact body (or the protrusion).

As shown in FIG. 1, an impact assembly for a power tool like the above-mentioned conventional rotary type impact tool is disclosed in U.S. Pat. No. 7,510,023. In U.S. Pat. No. 7,510,023, the hammer pins 33 are mounted in the hammer frame 31 to pivotally connect each hammer 32, 32B to the hammer frame 31. The output axle 40 is mounted in the hammer frame 31 and the engaging hole 321, 321B of each hammer 32, 32B and protrudes out of the through hole 313 of the hammer frame 31.

However, there are some problems to be overcome for the impact assembly disclosed in U.S. Pat. No. 7,510,023. Since each hammer pin 33 and each hammer 32, 32B are different components (i.e., each hammer pin 33 is not integrally formed as a part of each hammer 32, 32B) and the corresponding hammer pin 33 and hammer 32, 32B will form a gap therebetween, the mechanical strength of the hammers 32, 32B and the hammer pins 33 are insufficient, the vibration and abrasion issues of the hammers 32, 32B and the hammer pins 33 will be worse, the impact torque and the transmission efficiency will be lowered, and the lifetime of the impact assembly will be reduced. Furthermore, since the hammer frame 31 is open-type, such that broken parts (such as broken parts of the output axle 40 and the hammers 32, 32B resulted from a long-term impact operation) can spurt out and possibly injure the operator.

As shown in FIGS. 2 and 3, a double-ram striker assembly like the above-mentioned conventional rotary type impact tool is disclosed in U.S. Pat. No. 7,147,063. Similarly, in U.S. Pat. No. 7,147,063, the pins 43 are mounted in the hammer frame 44 to pivotally connect each ram body 30 to the hammer frame 44. The shaft body 21 is mounted in the hammer frame 44 and the engaging hole 45 of each ram body 30 and protrudes out of a through hole of the hammer frame 44.

However, there are some problems to be overcome for the double-ram striker assembly disclosed in U.S. Pat. No. 7,147,063. Since each pin 43 and each ram body 30 are different components (i.e., each pin 33 is not integrally formed as a part of each ram body 30) and the corresponding pin 43 and ram body 30 will form a gap therebetween, the mechanical strength of the ram bodies 30 and the pins 43 are insufficient, the vibration and abrasion issues of the ram bodies 30 and the pins 43 will be worse, the impact torque and the transmission efficiency will be lowered, and the lifetime of the impact assembly will be reduced. Furthermore, since the hammer frame 44 is open-type, such that broken parts (such as broken parts of the shaft body 21 and the ram bodies 30 resulted from a long-term impact operation) can spurt out and possibly injure the operator.

The present invention is, therefore, arisen to obviate or at least mitigate the above mentioned disadvantages.

### SUMMARY OF THE INVENTION

The main object of the present invention is to provide a transmission module at least to reduce vibration, enhance mechanical strength and torque, and increase the transmission efficiency and lifetime of the transmission module.

Another object of the present invention is to provide a transmission module to prevent broken parts from spurting out.

To achieve the above and other objects, an impact body of the present invention includes an impact body which is adapted for being mounted to a transmission module for an impact type pneumatic tool, wherein the transmission module has a rotation portion formed with a receiving space and an axle disposed in the receiving space.

The impact body includes a transmission ring and a protrusion, and the transmission ring has an inner circumferential surface and an outer circumferential surface. The inner circumferential surface defines a through hole which defines an axial direction, and the outer circumferential surface is formed with a limiting configuration. The protrusion extends outwardly from the outer circumferential surface and is integrally formed as a part of the transmission ring. The protrusion is parallel to the axial direction.

The impact body is adapted for being mounted to the rotation portion, received in the receiving space and swings around the protrusion. The through hole is noncircular and adapted for receiving the axle, and the impact body intermittently impacts the axle when rotating.

Since the transmission ring and the protrusion are integrally formed and form no gap therebetween, vibration and abrasion issues are improved, the mechanical strength of the impact body is enhanced, the rotation portion can directly transmit kinetic energy to the transmission ring when rotating, such that the transmission efficiency and lifetime of the transmission module are increased, and the waste of kinetic energy transmitted between the parts can be reduced.

Furthermore, since the transmission ring and the protrusion are integrally formed, the impact body can have a greater through hole and the sizes of the axle can be accordingly increased, such that the axle can have a greater impact radius for impacting the impact body, and the torque and the rotary output power is therefore effectively enhanced.

In addition, since the rotation portion of the transmission module is encompassed-type, such that it can prevent broken parts (such as broken parts of the axle and the impact body resulted from a long-term impact operation) in the rotation portion from spurting out, thus preventing the operator from danger.

Moreover, the impact body can be constrained not to impact the main body when the side surface of the recess is engaged against the pin, which prevents the impact body and the main body from breaking and avoids the waste of transmitted kinetic energy.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is an explosion diagram of an impact assembly for a power tool disclosed in U.S. Pat. No. 7,510,023;

FIGS. 2 and 3 show a double-ram striker assembly disclosed in U.S. Pat. No. 7,147,063;

FIG. 4 is a perspective breakdown drawing showing a pneumatic tool according to the present invention;

FIG. 4A is a perspective drawing showing a transmission module for a pneumatic tool according to the present invention;

FIG. 5 is a perspective drawing according to a first embodiment of the present invention;

FIG. 6 is a cross-sectional view according to the first embodiment of the present invention;

FIG. 7 is a perspective breakdown drawing according to the first embodiment of the present invention;

FIG. 8 is a perspective drawing showing an impact body according to the first embodiment of the present invention;

FIG. 9 is a front view of the impact body according to the first embodiment of the present invention;

FIG. 10 is a perspective drawing according to a second embodiment of the present invention;

FIG. 11 is a cross-sectional view showing according to the second embodiment of the present invention;

FIG. 12 is a perspective breakdown drawing according to the second embodiment of the present invention;

FIG. 12A is a perspective drawing according to FIG. 9 of the present invention; and

FIGS. 13 and 14 show an impact body according to the second embodiment of the present invention.

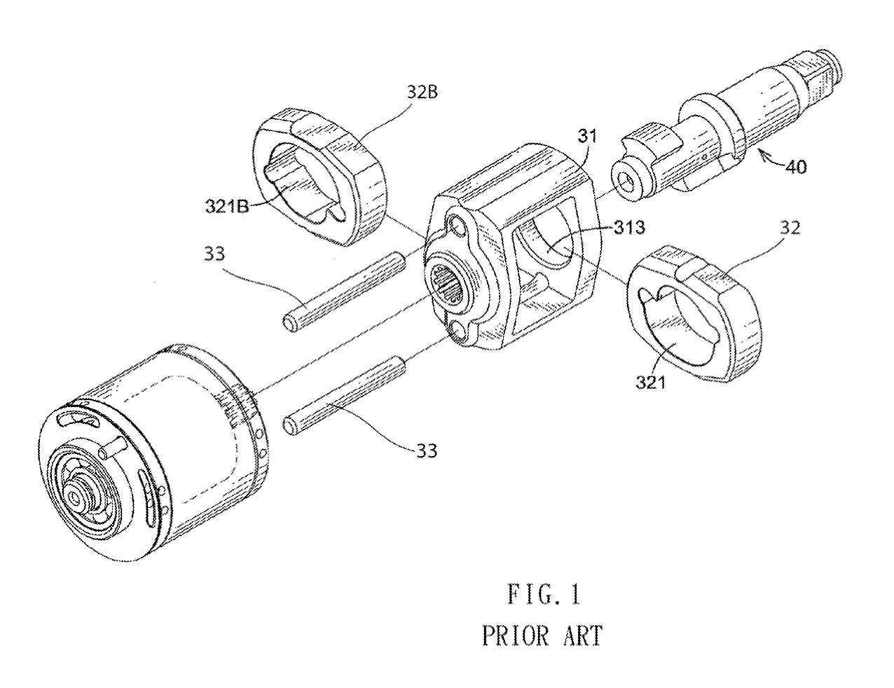

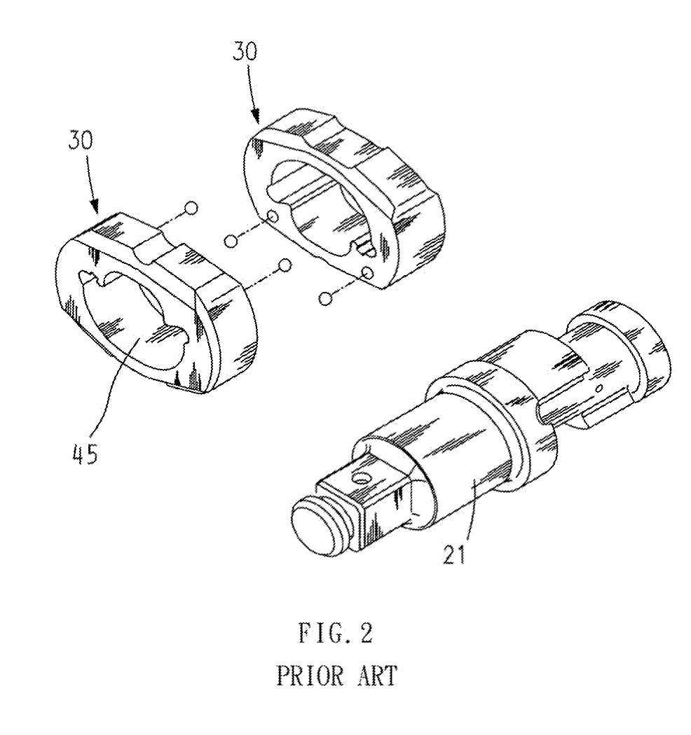

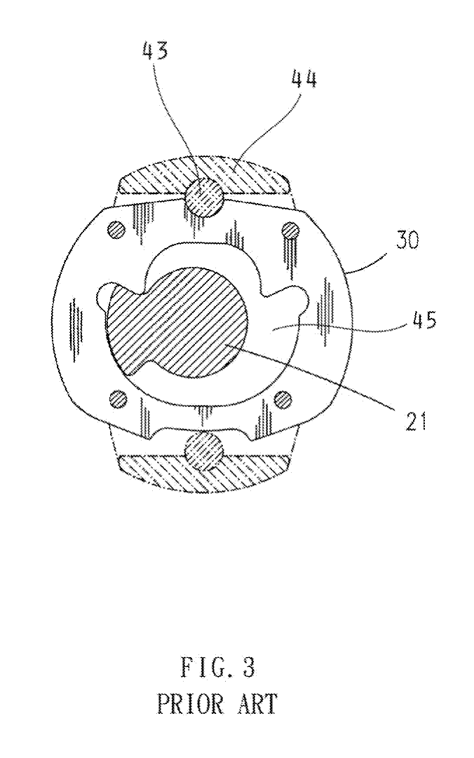

### DETAILED DESCRIPTION OF THE PREFERRED EMBODIMENTS

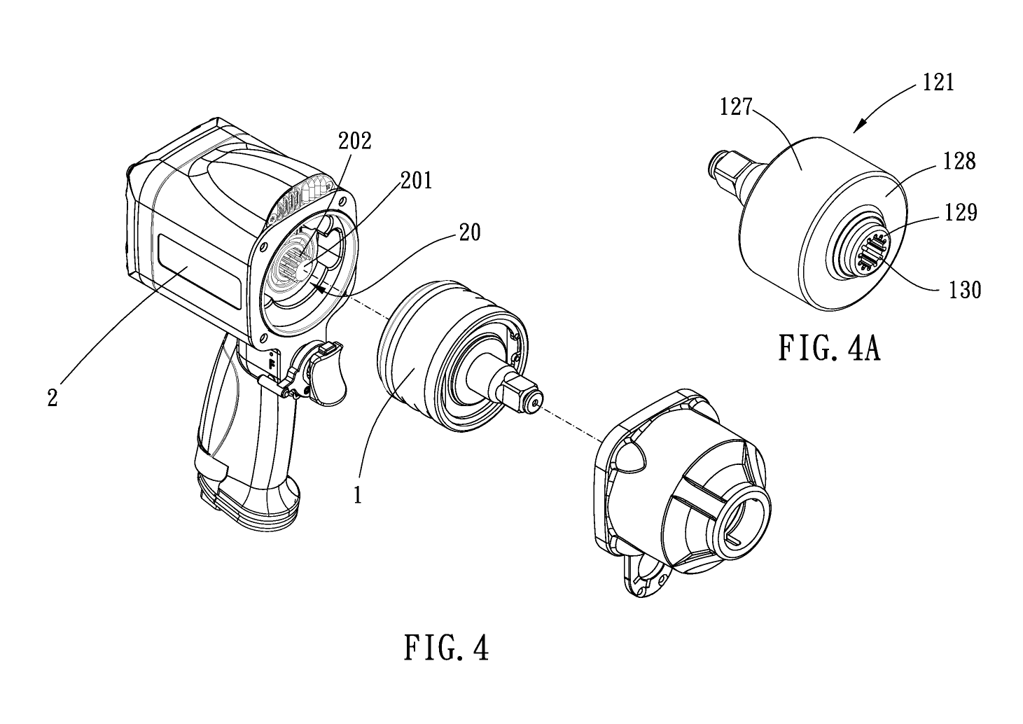

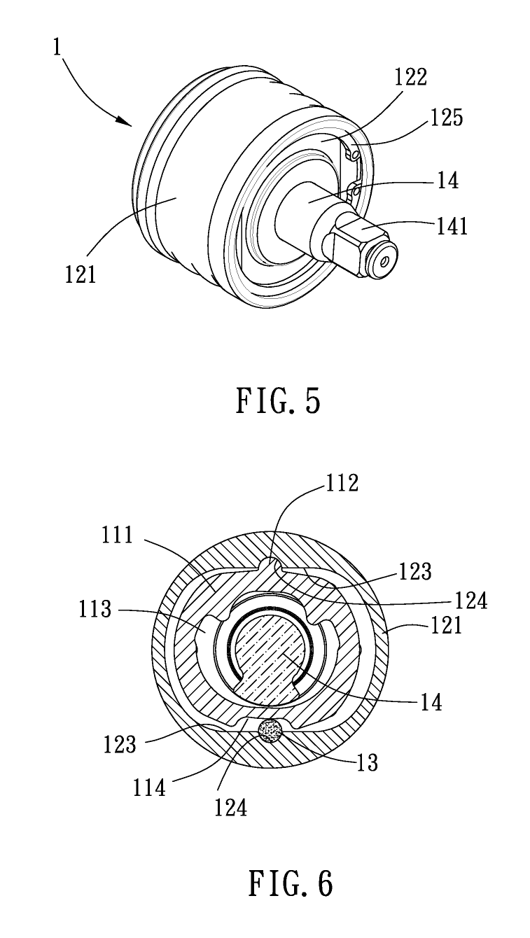

As shown FIGS. 4 and 5, a transmission module 1 according to a first embodiment of the present invention is provided. The transmission module 1 may be adapted for being mounted to a pneumatic tool 2 or the like that can provide rotary power, and can be driven by the tool 2 so as to output rotary power for impact effects.

As shown FIGS. 5 to 7, the transmission module 1 includes two impact bodies 11, a rotation portion, two pins 13 and an axle 14.

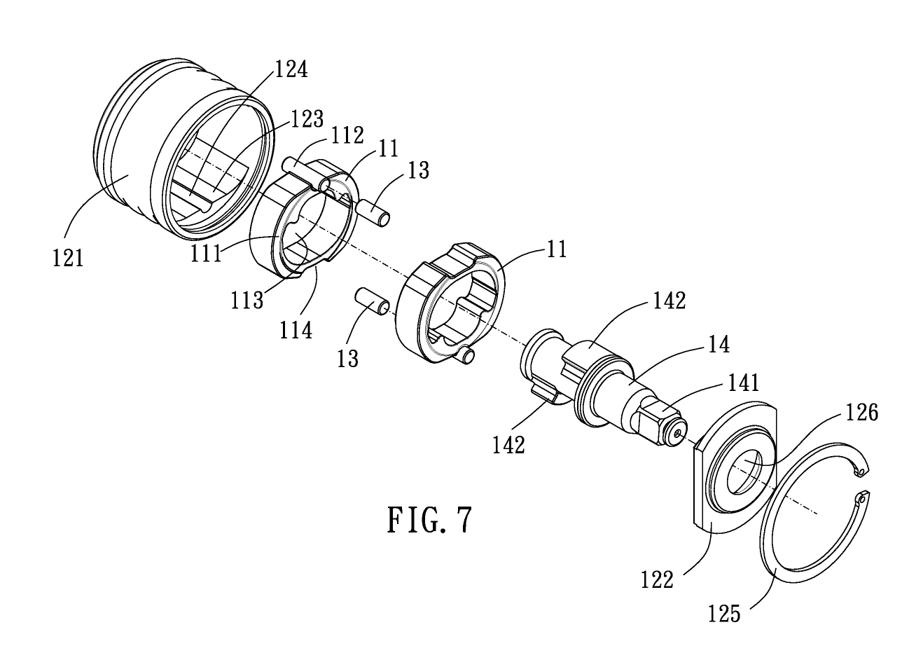

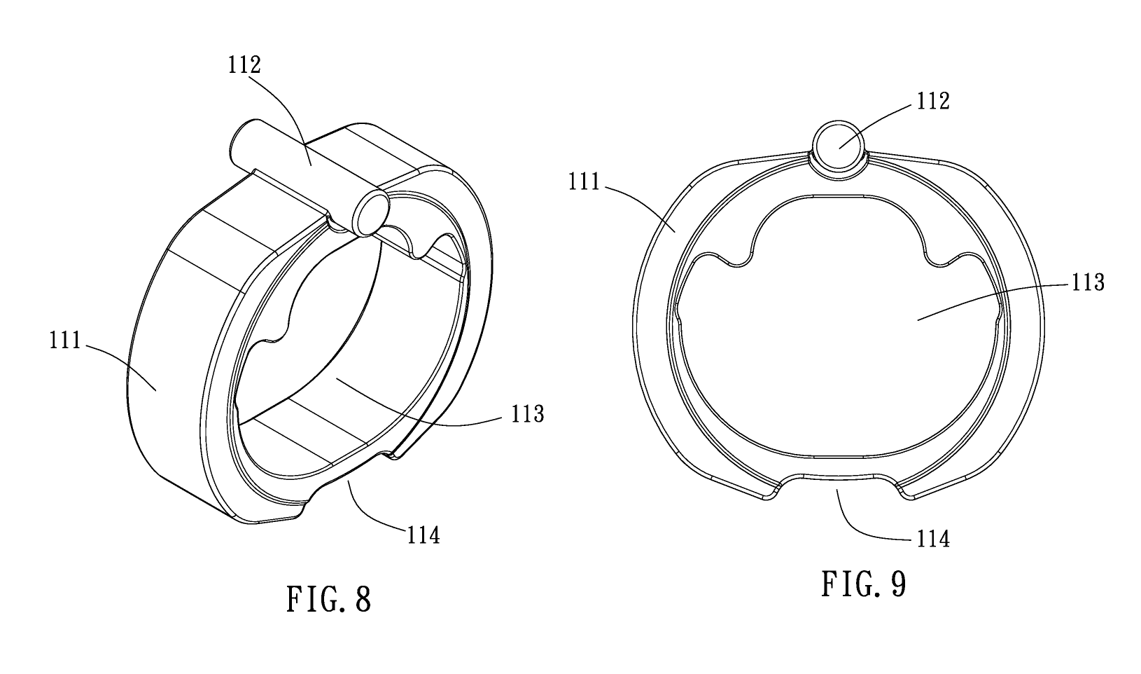

As shown FIGS. 7 to 10, the impact body 11 includes transmission ring 111 and a protrusion 112, and the transmission ring 111 has an inner circumferential surface and an outer circumferential surface. The inner circumferential surface defines a through hole 113, and the through hole 113 is noncircular and defines an axial direction. The outer circumferential surface is formed with a limiting configuration, and the protrusion 112 extends outwardly from the outer circumferential surface and is integrally formed as a part of the transmission ring 111, that is, the protrusion 112 and the transmission ring 111 are integrally formed in one piece. In this embodiment, the limiting configuration is a recess 114. The protrusion 112 and the recess 114 are oppositely formed at two sides of the impact body 11, and the protrusion 112 is parallel to the axial direction defined by the through hole 113. Preferably, along the axial direction, the extent of the protrusion 112 is larger than that of the transmission ring 111, so that the protrusion 112 protrudes from two side surfaces of the transmission ring 111, respectively.

As shown FIGS. 5 to 7, the rotation portion is formed with a receiving space, and more specifically, the rotation portion has a main body 121 and a cover 122, the main body 121 is substantially cannular and defines the receiving space therein. The main body 121 is formed with two pairs of symmetrical blocking walls 123 on the inner surface thereof and a groove 124 between each two of the blocking walls 123, thus allowing the two impact bodies 11 to be disposed in the receiving space through the opening of the cannular main body 121 and adjacently arranged in the receiving space. The protrusions 112 of the impact bodies 11 engage against and within the grooves 124, respectively, such that the two impact bodies 11 can swing around the respective protrusions 112. The two impact bodies 11 should be preferably oppositely disposed, that is, the protrusion 112 of one the impact body 11 engages against one of the grooves 124, and the protrusion 112 of the other impact body 11 engages against the other groove 124. In one preferably embodiment according to the present invention, since the protrusion 112 protrudes from two side surfaces of the transmission ring 111, respectively, this can avoid that the protrusions 112 of the two impact bodies 11 engage against the same groove 124 and allow the protrusion 112 of each impact body 11 is partially received in the recess 114 of the adjacent impact body 11. The cover 122 is adapted for covering the main body 121, and a retaining element 125 is engaged against the cover 122 so as to prevent the cover 122 and the impact bodies 11 from departing. The cover 122 is formed with an axle hole 126 corresponding to the main body 121. Additionally, the cover 122 may has a shape corresponding to that of the blocking wall 123, so as to be partially or wholly received in the receiving space.

The pins 13 cooperate with the respective impact bodies 11 and are disposed in the groove 124 which corresponds to the protrusion 112 of the corresponding impact body 11. In other words, as shown in FIG. 6, the protrusion 112 of one the impact body 11 engages against one of the grooves 124, and the corresponding pin 13 engages against the other groove 124, such that each pin 13 is received in the receiving space. Each pin 13 is received in the recess 114 of the impact body 11 and engages against the impact body 11. The recess 114 of the impact body 11 is larger than the pin 13, and the recess 114, and the pin 13 move correspondingly to each other when the impact body 11 swings.

One end of the axle 14 is formed with a working portion 141, the other end of the axle 14 is rotatably mounted to the rotation portion, disposed in the receiving space and through the axle hole 126 of rotation portion, and disposed through the through holes 113 of the respective impact bodies 11. More specifically, parts of the axle 14 within the respective through hole 113 are formed with projections 142 that have shapes corresponding to those of the respective through holes 113. Since the two impact bodies 11 are mounted in reverse and the axle 14 has two the projections 142 arranged in reverse, the impact bodies 11 intermittently impact the axle 14 when rotating, so as to drive the axle 14 to rotate.

By utilizing the above device, as shown in FIG. 4, the present invention can be adapted for being mounted to the pneumatic tool 2 or the like, so as to be driven by the rotor 20 of the pneumatic tool 2. As shown in FIG. 4A, in this embodiment, the main body 121 of the rotation portion includes a circumferential shell body 127 and a sidewall 128 which is substantially perpendicularly connected to the circumferential shell body 127, the sidewall 128 includes an engaging portion 129 having a central hole, a inner circumferential surface of the engaging portion 129 is formed with a first engaging structure 130, the first engaging structure is adapted to engage with a second engaging structure 202 of a shaft 201 of the rotor 20, and the first engaging structure 130 and second engaging structure 202 are complementary in shape. More specifically, the first engaging structure 130 includes a plurality of grooves axially alternatively formed on the inner circumferential surface of the engaging portion 129, and the second engaging structure 202 includes a plurality of axial teeth; however, the structures of the first engaging structure 130 and the second engaging structure 202 are not limited and can be modified according to various requirements. The rotation portion is connected with the rotor 20 via the engagement of the first engaging structure 130 and the second engaging structure 202, and the rotation portion can whereby be driven by the rotor 20.

Through that the impact bodies 11 intermittently impact the axle 14 as the impact bodies 11 rotate, the axle 14 can output, through the working portion 141, a greater rotary power to achieve the impact effects. Hence, an user can connect a socket or the like to the working portion 141, for assembling or disassembling a fastener, or driving other tools.

Given the above, since the transmission ring 111 and the protrusion 112 are integrally formed and form no gap therebetween, vibration and abrasion issues are improved, the mechanical strength of the impact body 11 is enhanced, the rotation portion can directly transmit kinetic energy to the transmission ring 111 when rotating, such that the transmission efficiency and lifetime of the transmission module 1 are increased, and the waste of kinetic energy transmitted between the parts can be reduced.

Furthermore, since the transmission ring 111 and the protrusion 112 are integrally formed, the impact body 11 can have a greater through hole 113 and the sizes of the axle 14 and the projection 142 can be accordingly increased, such that the axle 14 can have a greater impact radius for impacting the impact body 11, and the torque and the rotary output power is therefore effectively enhanced.

In addition, since the rotation portion of the transmission module 1 is encompassed-type, such that it can prevent broken parts (such as broken parts of the axle 14 and the impact body 11 resulted from a long-term impact operation) in the rotation portion from spurting out, thus preventing the operator from danger.

Moreover, the impact body 11 can be constrained not to impact the main body 121 when the side surface of the recess 114 is engaged against the pin 13, which prevents the impact body 11 and the main body 121 from breaking and avoids the waste of transmitted kinetic energy.

Since the rotation portion of the present invention includes the cannular main body 121 and is formed with the corresponding grooves 124 and blocking walls 123, it is simple in structure, easy to produce. Besides, since the impact bodies 11 have respective protrusions 112, the assembling orientations of the impact bodies 11 may not be considered, thus resulting in an easy assembly. When the secondly-assembled impact body 11 is assembled, the protruded protrusion 112 can prevent the two impact bodies 11 from being assembled in the same orientation, thus avoiding an erroneous assembly.

Furthermore, since the protrusion 112 is integrally formed as a part of the transmission ring 111, one side of the impact body 11 has an enlarged thickness. Under a condition with permissible structural strength, the sides, that face the protrusion 112, of the inner circumferential surface and the through hole 113 can be enlarged, such that the weight and the material of which the impact body 11 is made may be thereby reduced. Additionally, since part of the impact body 11 is cut down at the side which is near the axle 14, it will not affect the rotational inertia of the transmission module 1 much. The weight of the transmission module 1 can be reduced with an extremely minor influence of impact force, and the transmission module 1 can have excellent performance of use.

As the weight of the transmission module 1 is reduced, additional materials may be added to various parts, that are located at the periphery of the transmission module 1 and away from the axle 14, and this can increase the rotational inertia of the transmission module 1 with the same weight and increase the rotary output power.

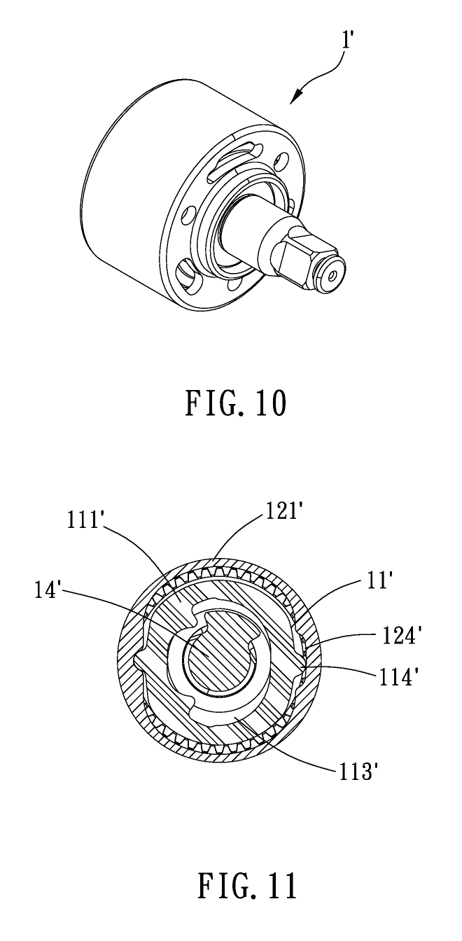

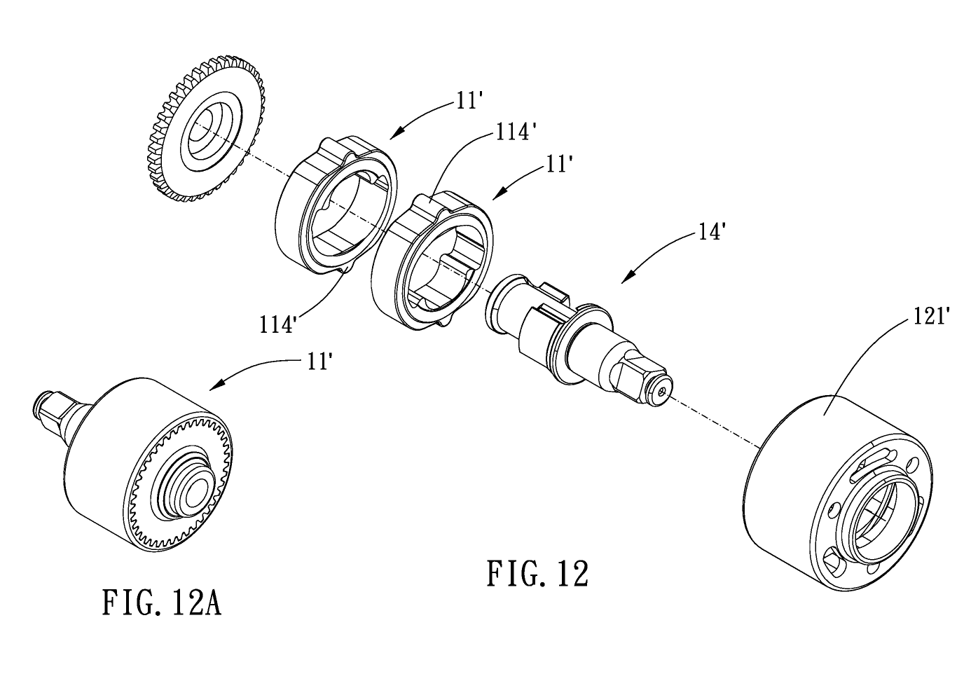

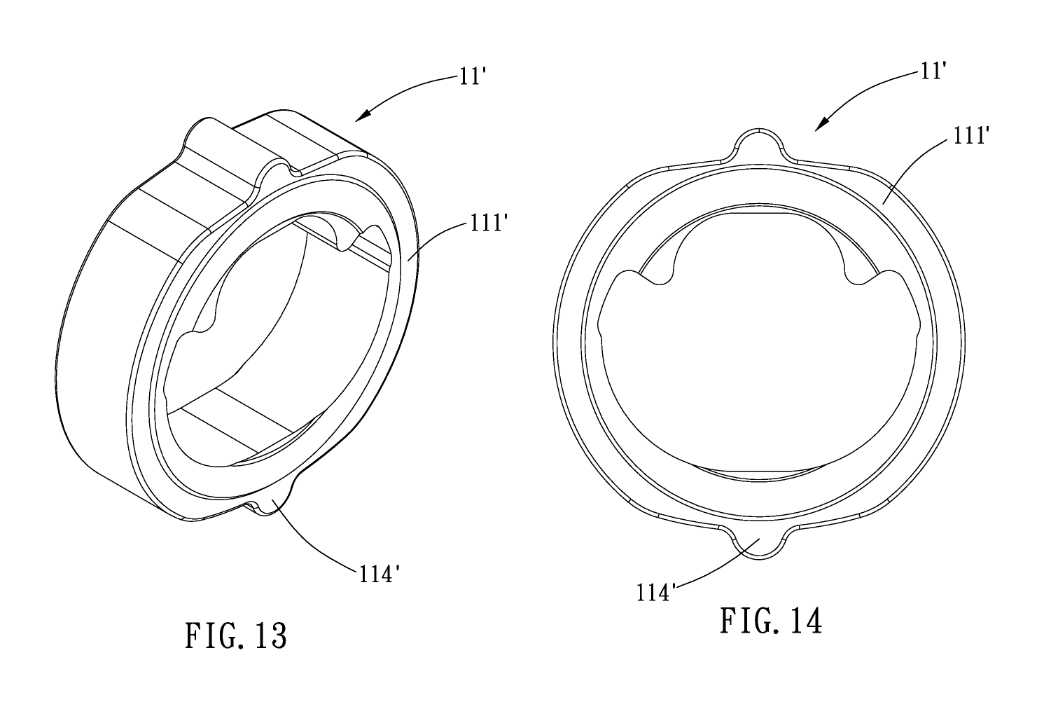

It should be noted that, in a second embodiment of the present invention as shown FIGS. 10 to 14, a rotation portion of a transmission module 1′ has a main body 121′. The main body 121′ includes a recess 124′ formed on the inner surface thereof.

Two impact bodies 11′ are mounted inside the main body 121′, and each impact body 11′ includes a projection 114′. The projection 114′ integrally protruding from the outer surface of the impact body 11′, and movably partially received within the recess 124′. Since the projection 114′ is integrally formed as a part of the impact body 11′, the impact body 11′ can have a greater through hole and the sizes of the axle 14′ can be accordingly increased, such that the axle 14′ can have a greater impact radius for impacting the impact body 11′, and the torque and the rotary output power is therefore effectively enhanced; besides, vibration and abrasion issues are improved, the mechanical strength of the impact body 11′ is enhanced, the transmission efficiency and lifetime of the transmission module 1′ are increased, and the waste of kinetic energy transmitted between the parts can be reduced.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An impact body, adapted for being mounted to a transmission module for an impact type pneumatic tool, the transmission module having a rotation portion formed with a receiving space and an axle, the axle being disposed in the receiving space;
wherein the impact body includes a transmission ring and a protrusion, the transmission ring has an inner circumferential surface and an outer circumferential surface, the inner circumferential surface defines a through hole which defines an axial direction, the protrusion extends outwardly from the outer circumferential surface and is integrally formed as a part of the transmission ring, and the protrusion is parallel to the axial direction;
wherein the impact body is adapted for being mounted to the rotation portion, received in the receiving space and swings around the protrusion;
wherein the through hole is noncircular and adapted for receiving the axle, and the impact body intermittently impacts the axle when rotating.

2. The impact body of claim 1, wherein the outer circumferential surface is formed with a recess, and the protrusion and the recess are oppositely formed at two sides of the impact body.

3. The impact body of claim 1, wherein the outer circumferential surface is formed with a projection, and the protrusion and the projection are oppositely formed at two sides of the impact body.

4. The impact body of claim 1, wherein along the axial direction, the extent of the protrusion is larger than that of the transmission ring.

5. A transmission module for a pneumatic tool, comprising at least one of the impact body of claim 1, and further comprising:
a rotation portion, formed with a receiving space, wherein the impact body is swingably mounted to the rotation portion, received in the receiving space and swings around the protrusion; and
an axle, rotatably mounted to the rotation portion, and disposed in the receiving space and through the through hole of the impact body.

6. The transmission module of claim 5, wherein the rotation portion includes a circumferential shell body and a sidewall which is substantially perpendicularly connected to the circumferential shell body, the sidewall includes an engaging portion having a central hole, a inner circumferential surface of the engaging portion is formed with a first engaging structure, the first engaging structure is adapted to engage with a second engaging structure of a shaft of a rotor, and the first and second engaging structures are complementary in shape.

7. The transmission module of claim 6, wherein the first engaging structure includes a plurality of grooves axially alternatively formed on the inner circumferential surface of the engaging portion, and the second engaging structure includes a plurality of axial teeth.

8. A transmission module for a pneumatic tool, comprising at least one of the impact body of claim 2, and further comprising:
a rotation portion, formed with a receiving space, wherein the impact body is swingably mounted to the rotation portion, received in the receiving space and swings around the protrusion;
an axle, rotatably mounted to the rotation portion, and disposed in the receiving space and through the through hole of the impact body; and
at least one pin, mounted to the rotation portion, disposed in the receiving space, received in the recess and engaged against the impact body, wherein the recess and the pin move correspondingly to each other when the impact body swings.

9. The transmission module of claim 8, wherein the rotation portion includes a circumferential shell body and a sidewall which is substantially perpendicularly connected to the circumferential shell body, the sidewall includes an engaging portion having a central hole, a inner circumferential surface of the engaging portion is formed with a first engaging structure, the first engaging structure is adapted to engage with a second engaging structure of a shaft of a rotor, and the first and second engaging structures are complementary in shape.

10. The transmission module of claim 9, wherein the first engaging structure includes a plurality of grooves axially alternatively formed on the inner circumferential surface of the engaging portion, and the second engaging structure includes a plurality of axial teeth.
